(19) United States
(12) Patent Application Publication
(10) Pub. No.: US 2008/0279982 A1
(43) Pub. Date: Nov. 13, 2008

(54) Reduced Fat Cheese Having Enhanced Organoleptic Properties

(76) Inventors: Jon Reeve, Glenview, IL (US); Jenni Justiz, Evanston, IL (US)

Correspondence Address: FITCH EVEN TABIN & FLANNERY, 120 S. LASALLE STREET, SUITE 1600, CHICAGO, IL, 60603-3406, US

(21) Appl. No.: 12/128,346

(22) Filed: May 28, 2008

Related U.S. Application Data
(63) Continuation-in-part of application No. 11/563,576, filed on Nov. 27, 2006.

(51) Int. Cl. A23C 19/00; A23C 19/06; A23C 19/02

(52) U.S. Cl. 426/36; 426/582

(57) ABSTRACT

The present invention is directed to reduced fat cheese blends and methods of producing reduced fat cheese blends having enhanced organoleptic properties relative to conventional reduced fat cheeses of a similar type and having approximately the same fat content produced by traditional make formulas.

This application is a continuation-in-part application of U.S. application Ser. No. 11/563,576, filed Nov. 27, 2006, which is incorporated herein by reference.

### FIELD OF THE INVENTION

The present invention is directed to reduced fat cheese blends and methods of producing reduced fat cheese blends having enhanced organoleptic properties relative to conventional reduced fat cheeses of a similar type and having approximately the same fat content produced by traditional make formulas.

### BACKGROUND OF THE INVENTION

A reduced fat product is one containing less than the full amount of fat for that particular food product. In some instances, a reduced fat product may be fat free or low fat. For example, full fat cow's milk (i.e. whole milk) naturally contains about 3.5 percent milk fat. Thus, cow's milk having two percent and one percent milk fat are examples of reduced fat milk products. One method of producing reduced fat cheese comprises using reduced fat milk rather than full fat milk during production.

The Food and Drug Administration defines cheddar cheese, i.e. full fat cheddar cheese, as having a minimum milkfat content of 50 percent by weight of the solids, and the maximum moisture content is 39 percent by weight. If the dairy ingredients used to make the cheddar cheese are not pasteurized, the cheese is cured at a temperature of not less than 35° F. for at least 60 days. The cheese is produced by treating a dairy product, such as milk, nonfat milk, or cream, with hydrogen peroxide/catalase, and is subjected to the action of a lactic acid-producing bacterial culture. One or more clotting enzymes, such as rennent, is added to the dairy ingredients. A semisolid mass is created which is cut, stirred, and heated with continued stirring, as to promote and regulate the separation of whey and curd. The whey is drained off, and the curd is matted into a cohesive mass. The mass is cut into slabs, which are piled and handled to promote drainage of whey and the development of acidity. The slabs are then cut into pieces, which may be rinsed by sprinkling or pouring water over them, with free and continuous drainage. The resulting curd is salted, stirred, further drained, and pressed into forms. One or more optional ingredients may be added during cheese production including calcium chloride, enzymes, antimycotic agents, and hydrogen peroxide/catalase.

The United States Department of Agriculture (USDA) Commercial Item Description (CID) requirements for labeling a cheese “reduced fat” specify that the reduced fat cheddar cheese contain about 25 to 33.3 percent less fat than that of regular cheddar cheese. Reduced fat cheddar cheese contains between about 19.2 and 22.9 percent total fat and between about 1.4 and 2.0 percent salt. Moisture content in reduced fat cheese is generally below about 49.0 percent. Reduced fat cheese generally has a pH value higher than 5.30, except shredded cheese, which generally has a pH value higher than 5.35.

There have been considerable technical efforts directed to providing reduced fat food products which have the texture, smoothness, taste, and other organoleptic properties of their full fat counterparts. With increasing consumer awareness, the focal point is on reducing fat and calorie consumption. Low fat, low calorie foods which look and taste similar to their full fat, higher calorie counterparts are eagerly sought by the consumer. Researchers in the food industry have concentrated on developing food products which are nutritious and palatable, containing substantially reduced levels of high calorie fat containing ingredients. Many reduced fat food products are intended to mimic the appearance, taste and texture, of traditional well known products that have a higher fat content.

### SUMMARY OF THE INVENTION

Described herein is a method for producing a reduced fat cheese product comprising curing fresh, reduced fat curds to produce a reduced fat cheese, curing fresh, full fat curds to produce a full fat cheese, mixing together the reduced fat cheese and the full fat cheese at a ratio of about 30 to 80 percent reduced fat cheese to about 20 to 70 percent full fat cheese, extruding the mixture of reduced fat cheese and full fat cheese, and equilibrating the mixture of reduced fat cheese and full fat cheese. The resulting reduced fat cheese product has enhanced organoleptic properties over conventional reduced fat cheese having the same fat content.

In another embodiment, the reduced fat cheese and the full fat cheese are mixed together at a ratio of 30 to 60 percent reduced fat cheese to about 40 to 70 percent full fat cheese.

In another embodiment the reduced fat cheese and the full fat cheese are mixed together at a ratio of 40 to 50 percent reduced fat cheese to about 50 to 60 percent full fat cheese. In one embodiment, the reduced fat cheese product is cheddar cheese.

In one embodiment, the reduced fat cheese is produced from one percent milk and the full fat cheese is produced from whole milk.

In one embodiment, the enhanced organoleptic properties are any of flavor, texture, mouthfeel, and taste. The enhanced organoleptic properties may be determined by sensory testing.

In one embodiment, the reduced fat cheese product has between 25 and 50 percent less fat than full fat cheese.

Also described herein is a method of producing a reduced fat cheese product comprising mixing together fresh, reduced fat curds and fresh, full fat curds at a ratio of about 30 to 80 percent fresh, reduced fat curds to about 20 to 70 percent fresh, full fat curds and aging the mixture of fresh, reduced fat curds and fresh, full fat curds. The resulting reduced fat cheese product has enhanced organoleptic properties over conventional reduced fat cheese having the same fat content.

In one embodiment, the mixture of fresh, reduced fat curds and fresh, full fat curds is accomplished by stirring.

Also described herein is a reduced fat cheese product comprising a mixture of reduced fat cheese and full fat cheese comprising about 30 to 80 percent reduced fat cheese and about 20 to 70 percent full fat cheese. The reduced fat cheese product has fat in the range of about 15 to 26 percent and enhanced organoleptic properties over conventional reduced fat cheese.

In one embodiment, the reduced fat cheese product may be extruded.

Also described herein is a reduced fat cheese product comprising a mixture of fresh, reduced fat cheese curds and fresh, full fat curds comprising about 30 to 80 percent fresh, reduced fat cheese curds and about 20 to 70 percent fresh, full fat cheese curds. The reduced fat cheese product has fat in the range of about 15 to 26 percent and enhanced organoleptic properties over conventional reduced fat cheese.

In one embodiment, the mixture of fresh, reduced fat cheese curds and fresh, full fat cheese curds is accomplished by stirring.

### BRIEF DESCRIPTION OF THE DRAWINGS

FIG. 1 is a flow diagram showing the process of preparing a reduced fat cheese according to one embodiment of the invention.

FIG. 2 is a bar graph which represents the percent fat, moisture, and salt profile for each of the cheese samples described in Example 1.

FIG. 3 is a spider plot showing flavor profiles for each of the cheese samples as described in Example 2.

FIG. 4 is a spider plot showing texture profiles for each of the cheese samples as described in Example 2.

FIG. 5 is a bar chart showing the intensity of sour and salty for each of the cheese samples as described in Example 2.

FIG. 6 is a spider plot showing flavor profiles for each of the cheese samples as described in Example 5.

FIG. 7 is a spider plot showing texture profiles for each of the cheese samples as described in Example 5.

### DETAILED DESCRIPTION OF THE INVENTION

The present invention is directed to reduced fat cheese blends and methods of producing reduced fat cheese blends having enhanced organoleptic properties relative to conventional reduced fat cheeses of a similar type and having approximately the same fat content produced by traditional make formulas. In one embodiment, cheese blends of the present invention have similar fat content to conventionally produced two percent sharp cheddar cheese, yet achieve an enhanced taste and texture profile when compared to the conventionally produced two percent sharp cheddar cheese. For the purposes of this application, a conventional reduced fat cheese is a cheese which is prepared from milk having the same reduced fat content. Thus, two percent cheese refers to cheese which has been produced using two percent milk. Likewise, one percent cheese refers to cheese which has been produced using one percent milk.

The methods and procedures described herein may be applied to any type of ripened cheese produced from any type of milk. Thus, generally, the methods and procedures are directed to cheeses that are made from milk where the milk is acidified and coagulated and the resulting curd is dehydrated, salted, fused together, and stored for flavor development. Examples of ripened cheese, include, but are not limited to, cheddar cheese, blue cheese, brie, gouda, havarti, hard grating cheese, and Swiss cheese. Different types of milk may be utilized to produce the ripened cheese, such as, for example, milk from cows, sheep, goats, yaks, water buffalo, horses, and camels. Preferably cow's milk is utilized.

Advantageously, the reduced fat cheese blends described herein have enhanced organoleptic properties over conventional reduced fat cheeses without the inclusion of additives, such as flavor enhancers. Although the methods and products described herein do not require additives to achieve enhanced organoleptic properties, additives may be added to the reduced fat cheeses in some embodiments.

In one embodiment, cheese blends are produced by combining and mixing together reduced fat cheese curds and full fat cheese curds. The curds may be aged curds or fresh curds. In one embodiment, the curds may be stirred together. Generally stirring creates smaller curd particles than milling. Although not wishing to be limited by theory, it is hypothesized that by stirring the curds a highly uniform mixture of reduced fat curds and full fat curds is produced. The small curd particles mix together into a highly uniform mixture. The mixture can then be aged into a cheese product having a uniform blend of reduced fat cheese curds and full fat cheese curds. Advantageously, the uniform cheese product has enhanced organoleptic properties because varying types of cheese curds are not discernable to the consumer. Certain methods of combining curds may not result in an optimally mixed product and the end cheese product may have marbling.

In any case, once the curds are mixed, the mixture is then aged (i.e. ripened) in blocks. Aging may be for varying periods of time, such as, for example between a few days to a few years. Generally, in the case of cheddar cheese, cheeses with a more intense, stronger, or sharper flavor are aged for longer periods of time than those cheeses having a less intense or milder flavor. Although these cheese blends have intermediate fat contents (i.e., intermediate between the values of the reduced fat and full fat cheese curds), their organoleptic properties are closer to the full fat variety (especially when compared to conventional cheese having a similar fat content).

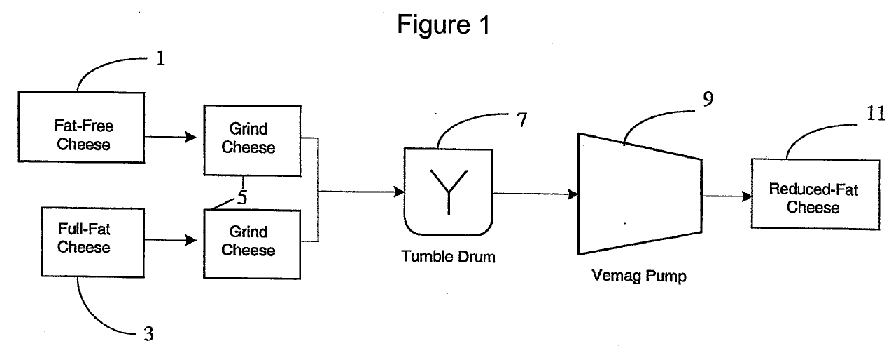

Another process for producing reduced fat cheese blends of the present invention is shown in FIG. 1. As shown in FIG. 1, cheese blends are produced by aging reduced fat or fat free curds 1 and full fat curds 3 separately. The aged cheeses are then reduced in size, combined, and mixed. Any method may be used for reducing the cheese size such as cubing, shredding, and grinding. As shown in FIG. 1, the cheeses are ground 5 and mixed together in a tumble drum 7 or similar mixing device. The mixture is then extruded through a pump 9, for example, a Vemag pump, or similar extruding device, to obtain a homogenous composition. The extruded cheese mixture may be refrigerated for several days to allow the cheeses to equilibrate. Although any period of time may be used to allow the cheese blends to equilibrate, in one embodiment equilibration occurs for two to three days. The result is a reduced fat cheese product 11 having enhanced organoleptic properties over conventional reduced fat cheese products having a similar fat content.

Although any ratio of reduced fat and full fat curds or cheese which produces a cheese product having a similar fat content as conventional reduced fat cheese may be used, ratios of reduced fat to full fat curds or cheese may fall within the range of about 30 to 80 percent reduced fat curds or cheese to about 20 to 70 percent full fat curds or cheese. In another embodiment, ratios of reduced fat to full fat cheese may fall in the range of about 30 to about 60 percent reduced fat curds or cheese to about 40 to about 70 percent full fat curds or cheese. In another embodiment, ratios of reduced fat to full fat curds or cheese may fall within the range of about 40 to 50 percent reduced fat curds or cheese to about 50 to 60 percent full fat curds or cheese. In another embodiment, ratios of reduced fat to full fat curds or cheese may fall within the range of about 41 to 50 percent reduced fat curds or cheese to about 50 to 59 percent full fat curds or cheese. For example, ratios of reduced fat to full fat curds or cheese are 35 percent reduced fat to 65 percent full fat, 36 percent reduced fat to 64 percent full fat, 37 percent reduced fat to 63 percent full fat, 38 percent reduced fat to 62 percent full fat, 39 percent reduced fat to 61 percent full fat, 40 percent reduced fat to 60 percent full fat, 41 percent reduced fat to 59 percent full fat, 42 percent reduced fat to 58 percent full fat, 43 percent reduced fat to 57 percent full fat, 44 percent reduced fat to 56 percent full fat, 45 percent reduced fat to 55 percent full fat, 46 percent reduced fat to 54 percent full fat, 47 percent reduced fat to 53 percent full fat, 48 percent reduced fat to 52 percent full fat, 49 percent reduced fat to 51 percent full fat, 50 percent reduced fat to 50 percent full fat, 51 percent reduced fat to 49 percent full fat, 52 percent reduced fat to 48 percent full fat, 53 percent reduced fat to 47 percent full fat, 54 percent reduced fat to 46 percent full fat, and 55 percent reduced fat to 45 percent full fat.

In another embodiment, a plurality of blends, comprising two or more blends containing any ratio of reduced fat and full fat cheese or curds may be combined to produce a reduced fat cheese product having enhanced organoleptic properties.

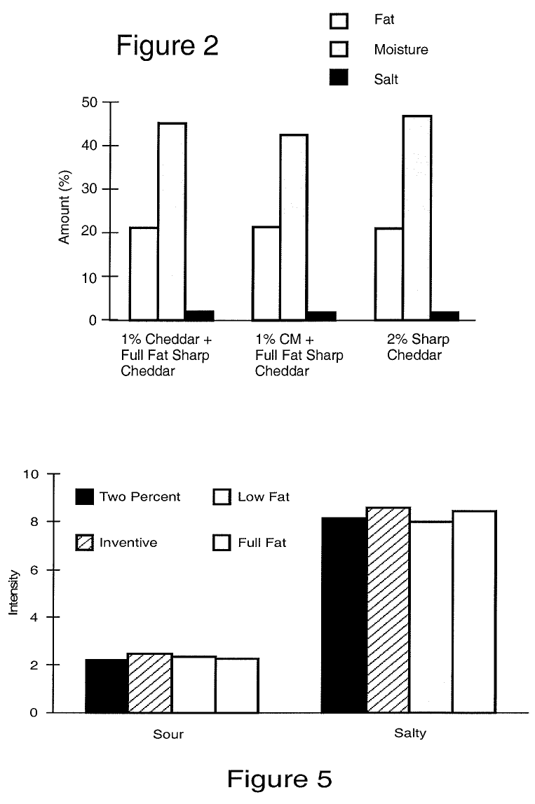

In any case, cheese blends produced by the methods herein may be combined and mixed in ratios sufficient to produce a reduced fat cheese having similar moisture, fat, and salt profile as conventional reduced fat cheese products. In another embodiment, pH may be added to the profile. Although the cheese blends produced by the methods herein have a similar content profile (e.g. moisture, fat, salt, and/or pH) to conventional reduced fat cheese products, unexpectedly, the cheese blends described herein have enhanced flavor and texture over conventional reduced fat cheese products. FIG. 2 is an example of a moisture, fat, and salt content profile and is further described herein below in Example 1.

The cheese blends described herein advantageously have enhanced organoleptic properties over conventional cheese blends with similar fat, moisture, salt, and/or pH content. Enhanced organoleptic properties may be determined by a trained sensory panel. In one example, a sensory panel may be given a blind test to describe the various components of taste and texture. In such sensory tests, the panel members may be given reduced fat cheese developed by the methods described herein as well as full fat cheese and conventionally prepared reduced fat cheese.

In the case of sensory tests designed to determine the similarities and differences in flavor, panel members are asked to describe numerous properties which have been used in evaluating dairy products. Such properties include, for example, milk impression, two percent milk impression, NFDM/cardboard/casein impression, dairy acids impression, butyric acid impression, lactic acid impression, buttertype impression, sweet cream butter impression, diacetyl impression, brown impression, fruity impression, floral/perfumy impression, savory impression, nutty impression, waxy/plastic impression, and/or vegetable impression. During testing each sensory panel member records their findings for each cheese sample using a 15 point scale that has been calibrated with reference samples used to identify the intensities of certain scale points. This is referred to as the spectrum descriptive analysis method. The data from the sensory test can then be mapped out on a spider plot.

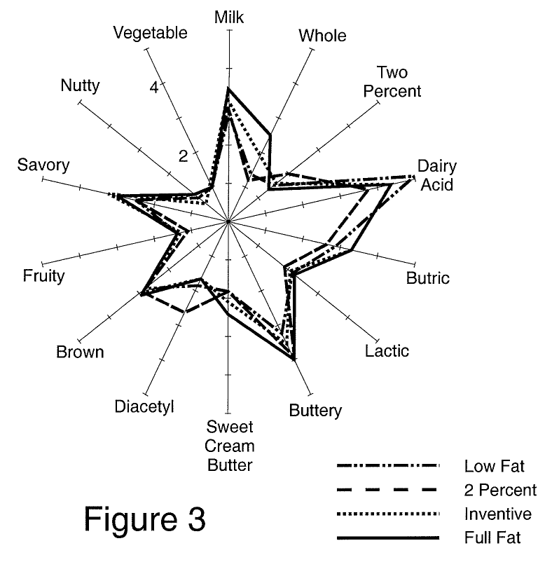

FIG. 3 is an example of a spider plot displaying the results of such a sensory test comparing two percent sharp cheddar, a one percent/full fat sharp cheddar blend, one percent cheddar cheese, and full fat sharp cheddar. Each cheese has a unique flavor profile based on its properties as described by the sensory panelists. In this case, cheeses having profiles similar to each other have similar flavor. Cheeses having similar profiles to each other are shown where the plotted lines are close to each other in certain areas. Alternatively, cheeses having less similar profiles have less similar flavor. Less similarity is shown where the plotted lines are further apart in certain areas. Various cheese plot lines converge where data values compiled from the sensory panel are similar and the plot lines diverge where the data values are dissimilar. As shown in FIG. 3, the profile of the inventive sample prepared by blending reduced fat and full fat cheese closely approximates the profile of the full fat cheese and is further displaced from the profiles of the reduced fat cheeses.

Alternatively or in addition to flavor tests, sensory tests are available to determine the similarities and differences in texture/mouthfeel. In this case, panel members are asked to describe numerous properties for each cheese, such as, for example, firmness, cohesiveness of mass, adhesiveness of mass, moistness, rate of breakdown, mouthcoating intensity, dairy film, and/or chalky/grainy. During testing each sensory panelist records their findings for each cheese sample. The data from the sensory test can also be mapped out on a spider plot.

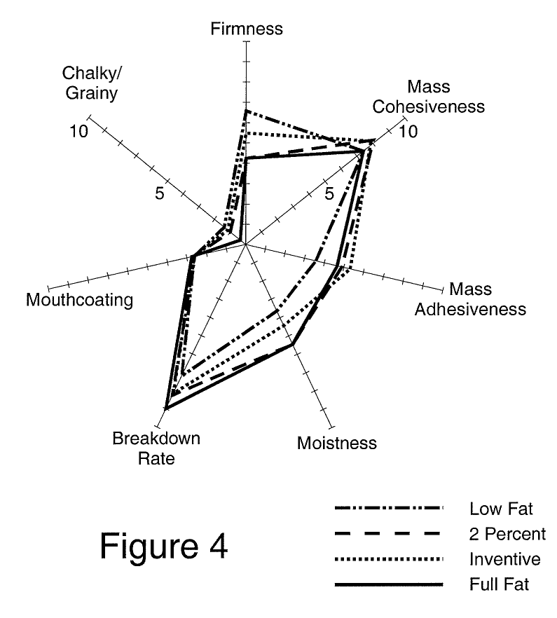

FIG. 4 is an example of a spider plot displaying the results of such a sensory test comparing two percent sharp cheddar, a one percent/full fat sharp cheddar blend, one percent cheddar cheese, and full fat sharp cheddar. Each cheese has a unique texture/mouthfeel profile based on its properties as described by the sensory panel. In this case, cheeses having profiles similar to each other have similar texture/mouthfeel. Cheeses having similar profiles to each other are shown where the plotted lines are close to each other in certain areas. Alternatively, cheeses having less similar profiles have less similar texture/mouthfeel. Less similarity is shown where the plotted lines are further apart in certain areas. Various cheese plot lines converge where data values compiled from the sensory panel are similar and the plot lines diverge where the data values are dissimilar. As shown in FIG. 4, the profile of the inventive sample prepared by blending reduced fat and full fat cheese closely approximates the profile of the full fat cheese and is further displaced from the profiles of the reduced fat cheeses.

In yet another sensory test, panelists were asked to rate cheese samples from 1 to 15 for intensity of various taste properties, such as, for example sour and salty. The results from such testing can be displayed in a bar graph such as FIG. 5. Cheeses having similar intensities (sour, salty) have bars of similar height.

### EXAMPLES

A better understanding of the present embodiment and its many advantages may be clarified with the following examples, given by way of illustration.

### Example 1

Two separate cheese blends were produced by mixing one percent cheddar with full fat cheddar and one percent Cheddar for Manufacturing (CM) with full fat cheddar. CM is similar to cheddar cheese as described above, except that it is intended for the use in the manufacture of process cheese.

The one percent/full fat sharp cheddar blend was produced by grinding the one percent cheddar and the full fat sharp cheddar. 30 pounds of the ground one percent cheddar was combined with 32.5 pounds of the ground full fat sharp cheddar, yielding a 48/52 blend. Next, the ground cheeses were combined in a tumble drum for even distribution of the cheeses. The blend was then extruded using a Vemag pump and collected. The resultant one percent/full fat sharp cheddar blend was vacuum sealed and refrigerated to allow the mixture to equilibrate. After five days, the cheese blend was evaluated by a team of cheese experts for flavor and texture in comparison to conventional reduced fat, fat free, and full fat cheddar cheeses. Fat, moisture, protein, and salt were measured analytically.

The one percent CM/full fat sharp cheddar blend was produced by grinding the one percent CM and the full fat sharp cheddar. 35 pounds of the ground one percent CM was combined with 35 pounds of the ground full fat sharp cheddar, yielding a 50/50 blend. Next, the ground cheeses were combined in a tumble drum for even distribution of the cheeses. The blend was then extruded using a Vemag pump and collected. The resultant one percent CM/full fat sharp cheddar blend was vacuum sealed and refrigerated to allow the mixture to equilibrate. After five days, the cheese blend was evaluated by a team of cheese experts for flavor and texture in comparison to conventional reduced fat, fat free, and full fat cheddar cheeses. Fat, moisture, protein, and salt were measured analytically.

The percent fat, moisture, and salt profile for each blend was measured and compared to the percent fat, moisture, and salt profile of two percent sharp cheddar. As shown in FIG. 2, the one percent cheddar/full fat sharp cheddar blend had fat levels similar to the two percent sharp cheddar. The analytical data follows:

| | | | | 1% Ched- | | |
|---|---|---|---|---|---|---|
| | Full- | | | dar + | 1% CM + | |
| | Fat | 1% | | Full | Full Fat | 2% |
| | Sharp | Ched- | 1% | Fat Sharp | Sharp | Sharp |
| | Cheddar | dar | CM | Cheddar | Cheddar | Cheddar |
| Fat | 35.09 | 7.95 | 9.23 | 21.26 | 21.28 | 21 |
| Moisture | 37.2 | 53.2 | 47.4 | 45.1 | 42.5 | 46.3 |
| Salt | 1.98 | 2.11 | 1.85 | 1.95 | 1.89 | 1.9 |
| Protein | 22.6 | 32.3 | 37.0 | 27.2 | 29.7 | Not |
| | | | | | | Available |

### Example 2

The one percent/full fat sharp cheddar blend from Example 1 above was tested by a trained sensory panel against three samples. The samples included two percent sharp cheddar, one percent cheddar, and full fat sharp cheddar. The samples were tested for flavor, texture, and taste by a sensory panel.

FIG. 3 is a spider plot showing flavor profiles for each of the four samples. As shown in FIG. 3, the one percent/full fat sharp cheddar blend (labeled on the plot as “inventive”) has a flavor profile more similar to the full fat sharp cheddar sample than the two percent sharp cheddar sample even though the fat content of the inventive sample is closer to that of the two percent sample. Thus, the one percent/full fat sharp cheddar blend has enhanced flavor properties over conventional two percent sharp cheddar. The mean values for FIG. 3 are as follows:

| | | | Two | | | |
|---|---|---|---|---|---|---|
| | | Whole | Percent | Dairy | Butyric | Lactic |
| | Milk | Milk | Milk | Acids | Acid | Acid |
| Sample | Impression | Impression | Impression | Impression | Impression | Impression |
| 2% | 3.0 | 1.2 | 2.0 | 3.8 | 2.6 | 1.9 |
| Sharp | | | | | | |
| Cheddar | | | | | | |
| Inventive | 3.3 | 1.9 | 1.6 | 4.4 | 3.3 | 2.1 |
| Low Fat | 2.9 | 1.4 | 1.5 | 5.0 | 2.9 | 2.2 |
| Full Fat | 3.5 | 2.5 | 1.3 | 4.4 | 3.3 | 2.2 |
| Sharp | | | | | | |
| Cheddar | | | | | | |

| | | Sweet | | | | |
|---|---|---|---|---|---|---|
| | | Cream & | | | | |
| | Buttery | Butter | Diacetyl | Brown | Fruity | Savory |
| Sample | Impression | Impression | Impression | Impression | Impression | Impression |
| 2% | 4.0 | 1.8 | 2.6 | 2.9 | 1.1 | 2.5 |
| Sharp | | | | | | |
| Cheddar | | | | | | |
| Inventive | 3.5 | 2.1 | 1.7 | 2.9 | 1.3 | 3.3 |
| Low Fat | 3.3 | 1.8 | 1.9 | 2.8 | 1.4 | 2.6 |
| Full Fat | 4.0 | 2.4 | 1.6 | 3.1 | 1.4 | 3.1 |
| Sharp | | | | | | |
| Cheddar | | | | | | |

| | Nutty | Vegetable |
|---|---|---|
| Sample | Impression | Impression |
| 2% | 0.9 | 1.0 |
| Sharp | | |
| Cheddar | | |
| Inventive | 0.7 | 1.1 |
| Low Fat | 1.2 | 1.0 |
| Full Fat | 1.1 | 1.0 |
| Sharp | | |
| Cheddar | | |

FIG. 4 is a spider plot showing texture/mouthfeel profiles for each of the four samples. As shown in FIG. 4, the one percent/full fat sharp cheddar blend (labeled on the plot as “inventive”) has a texture/mouthfeel profile more similar to the full fat sharp cheddar sample than the two percent sharp cheddar sample even though the fat content of the inventive sample is closer to that of the two percent sample. Thus, the one percent/full fat sharp cheddar blend has enhanced texture/mouthfeel properties over conventional two percent sharp cheddar. The mean values for FIG. 4 are as follows:

| | | | | | | Mouth | |
|---|---|---|---|---|---|---|---|
| | | Cohesiveness | Adhesiveness | | Rate of | Coating | Chalky/ |
| Sample | Firmness | of Mass | of Mass | Moistness | Breakdown | Intensity | Grainy |
| 2% Sharp | 4.2 | 8.1 | 4.9 | 5.4 | 8.3 | 2.6 | 1.0 |
| Cheddar | | | | | | | |
| Inventive | 5.5 | 8.0 | 5.3 | 4.4 | 8.2 | 2.6 | 1.1 |
| Low Fat | 6.5 | 7.4 | 3.6 | 3.6 | 7.3 | 2.6 | 1.4 |
| Full Fat | 4.2 | 7.3 | 4.7 | 5.5 | 9.2 | 2.8 | 0.4 |
| Sharp | | | | | | | |
| Cheddar | | | | | | | |

FIG. 5 is a bar chart showing the intensity of sour and salty tastes for each of the four samples. As shown in FIG. 5, the one percent/full fat sharp cheddar blend (labeled on the plot as “inventive”) has a salty intensity most similar to full fat sharp cheddar. The intensity values were measured by a sensory panel where each sample received a value on an arbitrary scale of 1 to 15. The mean values for FIG. 5 are as follows:

| Sample | Sour | Salty |
|---|---|---|
| 2% | 2.2 | 8.1 |
| Sharp | | |
| Cheddar | | |
| Inventive | 2.5 | 8.6 |
| Low Fat | 2.3 | 8.0 |
| Full Fat | 2.3 | 8.5 |
| Sharp | | |
| Cheddar | | |

### Example 3

A reduced fat cheddar cheese was produced by combining full fat cheddar and fat free cheddar cheeses. The cheese mixture consisted of 47 percent fat free cheddar and 53 percent full fat cheddar. The cheeses were cubed into ⅝ inch cubes and combined in a tumble drum, and the mixture was extruded through the Vemag to produce a cheese log of reduced fat cheddar cheese. The reduced fat cheese was then refrigerated to allow the cheeses to equilibrate. After four days the samples were evaluated by a team of cheese experts for flavor and texture vs. fat free cheddar, full fat cheddar, and two percent cheddar. The team observed that the reduced fat cheese blend had a flavor more similar to full fat cheese than either the fat free cheese or the two percent cheddar cheese.

Fat, moisture, salt, and protein were measured analytically for each sample. The percent fat, moisture, salt, and protein of the reduced fat cheese blend was measured and compared to the percent fat, moisture, salt, and protein of fat free cheddar cheese and full fat mild cheddar cheese. The analytical data follows:

| | Fat Free | Full Fat Mild | Reduced Fat |
|---|---|---|---|
| | Cheddar | Cheddar | Cheese Blend |
| Fat | 1.08 | 33.37 | 17.43 |
| Moisture | 56.95 | 37.40 | 47.13 |
| Salt | 1.95 | 1.48 | 1.79 |
| Protein | 33.80 | 24.77 | 28.79 |

### Example 4

A reduced fat cheddar cheese was produced by combining full fat cheddar and fat free cheddar cheeses. The cheese mixture consisted of 43 percent fat free cheddar and 57 percent full fat cheddar. The cheeses were shredded and combined in a tumble drum, and the mixture was extruded through the Vemag to produce a cheese log of reduced fat cheddar cheese. The reduced fat cheese was then refrigerated to allow the cheeses to equilibrate. After four days the samples were evaluated by a team of cheese experts for flavor and texture vs. fat free cheddar, full fat cheddar, and two percent cheddar. The team observed that the reduced fat cheese blend had a flavor more similar to full fat cheese than either the fat free cheese or the two percent cheddar cheese. Fat, moisture, salt, and protein were measured analytically for each sample. The percent fat, moisture, salt, and protein of the reduced fat cheese blend was measured and compared to the percent fat, moisture, salt, and protein of fat free cheddar cheese and full fat mild cheddar cheese. The analytical data follows:

| | Fat Free | Full Fat Mild | Reduced Fat |
|---|---|---|---|
| | Cheddar | Cheddar | Cheese Blend |
| Fat | 1.08 | 33.37 | 19.57 |
| Moisture | 56.95 | 37.40 | 46.78 |
| Salt | 1.95 | 1.48 | 1.75 |
| Protein | 33.80 | 24.77 | 28.68 |

### Example 5

A reduced fat cheddar curd blend was produced by combining and mixing fresh, reduced fat cheddar curds and fresh, full fat mild cheddar curds. The curd mixture consisted of 43 percent fat free cheddar curds and 57 percent full fat mild cheddar curds. The mixture was stirred in an open natural cheese drain table and then aged in blocks. The resulting reduced fat cheese blend was tested against three samples including, two percent cheddar cheese, fat free cheddar cheese, and full fat mild cheddar cheese. The samples were tested for flavor, texture, and taste by a sensory panel. Fat, moisture, salt, protein, and pH were measured analytically for each sample. The percent fat, moisture, salt, protein, and pH profile for the reduced fat cheese blend was measured and compared to the percent fat, moisture, salt, protein, and pH profile of two percent cheddar. The reduced fat cheese blend had fat levels similar to the two percent cheddar cheese. The analytical data follows:

| | Fat Free | Full Fat Mild | | Reduced Fat |
|---|---|---|---|---|
| | Cheddar | Cheddar | 2% Cheddar | Cheese Blend |
| Fat | 0.35 | 31.71 | 19.24 | 19.06 |
| Moisture | 56.4 | 39.9 | 48.5 | 48.2 |
| Salt | 1.90 | 2.03 | 1.67 | 2.05 |
| Protein | 35.0 | 22.7 | 26.5 | 27.3 |
| pH | 5.10 | 5.38 | 5.18 | 4.99 |

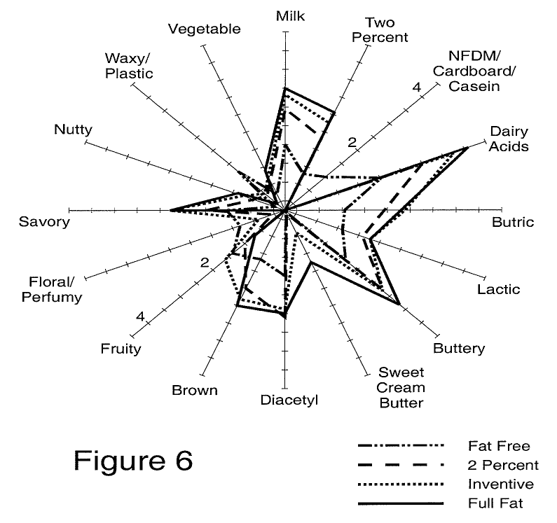

FIG. 6 is a spider plot showing flavor profiles for each of the four samples. As shown in FIG. 6, the reduced fat cheese blend (labeled on the plot as “inventive”) has a flavor profile more similar to the full fat mild cheddar sample than the two percent cheddar sample. Thus, the reduced fat cheese blend has enhanced flavor properties over conventional two percent cheddar even though the fat content of the inventive sample is closer to that of the two percent sample. The mean values for FIG. 6 are as follows:

| | | Two | NFDM/ | | Butyric |
|---|---|---|---|---|---|
| | Milk | Percent | Cardboard/ | Dairy | Acid |
| | Impres- | Milk | Casein | Acids | Impres- |
| Sample | sion | Impression | Impression | Impression | sion |
| 2% | 2.5 | 2.0 | 0.0 | 3.1 | 2.1 |
| Cheddar | | | | | |
| Fat Free | 1.7 | 1.0 | 1.2 | 2.2 | 1.3 |
| Full Fat | 3.1 | 2.6 | 0.0 | 4.1 | 2.3 |
| Mild | | | | | |
| Cheddar | | | | | |
| Inventive | 2.9 | 2.4 | 0.0 | 3.8 | 2.5 |

| | | | Sweet | | | |
|---|---|---|---|---|---|---|
| | Lactic | Butter- | Cream | | | |
| | Acid | Type | Butter | Diacetyl | Brown | Fruity |
| Sample | Impression | Impression | Impression | Impression | Impression | Impression |
| 2% | 1.81 | 2.9 | 0.1 | 2.7 | 2.1 | 1.2 |
| Cheddar | | | | | | |
| Fat Free | 1.3 | 1.8 | 0.1 | 1.7 | 1.3 | 1.5 |
| Full Fat | 1.9 | 3.4 | 1.4 | 2.6 | 2.6 | 0.9 |
| Mild | | | | | | |
| Cheddar | | | | | | |
| Inventive | 1.9 | 2.9 | 0.6 | 2.5 | 2.4 | 1.8 |

| | Floral/ | | | | |
|---|---|---|---|---|---|
| | Perfumy | Savory | Nutty | Waxy/ | |
| | Impres- | Impres- | Impres- | Plastic | Vegetable |
| Sample | sion | sion | sion | Impression | Impression |
| 2% Sharp | 0.3 | 1.7 | 0.7 | 0.5 | 0.8 |
| Cheddar | | | | | |
| Fat Free | 1.0 | 1.3 | 0.3 | 1.4 | 0.4 |
| Full Fat | 0.1 | 2.4 | 1.1 | 0.2 | 1.1 |
| Mild | | | | | |
| Cheddar | | | | | |
| Inventive | 0.6 | 2.4 | 0.9 | 0.6 | 1.0 |

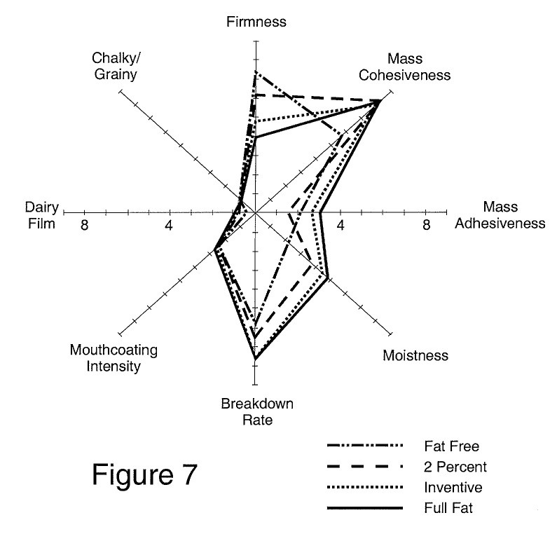

FIG. 7 is a spider plot showing texture/mouthfeel profiles for each of the four samples. As shown in FIG. 7, the reduced fat cheese blend (labeled on the plot as “inventive”) has a texture/mouthfeel profile more similar to the full fat mild cheddar sample than the two percent cheddar sample even though the fat content of the inventive sample is closer to that of the two percent sample. Thus, the reduced fat cheese blend has enhanced texture/mouthfeel properties over conventional two percent cheddar. The mean values for FIG. 7 are as follows:

| | | Cohesive- | Adhesive- | | |
|---|---|---|---|---|---|
| | Firm- | ness | ness | Moist- | Rate of |
| Sample | ness | of Mass | of Mass | ness | Breakdown |
| 2% | 6.1 | 8.3 | 1.5 | 3.8 | 6.6 |
| Cheddar | | | | | |
| Fat Free | 7.4 | 5.7 | 2.1 | 2.2 | 5.9 |
| Full Fat | 4.0 | 8.2 | 3.0 | 4.8 | 7.6 |
| Mild | | | | | |
| Cheddar | | | | | |
| Inventive | 4.8 | 8.0 | 2.7 | 4.5 | 7.6 |

| | Mouthcoating | | |
|---|---|---|---|
| Sample | Intensity | Dairy Film | Chalky/Grainy |
| 2% Cheddar | 2.4 | 0.8 | 0.9 |
| Fat Free | 2.4 | 0.4 | 1.0 |
| Full Fat Mild | 7 2. | 1.0 | 0.9 |
| Cheddar | | | |
| Inventive | 2.6 | 0.8 | 1.0 |

### Example 6

A reduced fat cheddar curd blend was produced at a commercial cheese make plant by combining and mixing fresh, reduced fat cheddar curds with fresh, full fat milk cheddar curds. The curd mixture consisted of 827 pounds fat free cheddar curds and 921 pounds full fat milk cheddar curds, equating to a 43/57 fat free/full fat cheddar curd blend. The mixture was stirred in an open natural cheese drain table, packaged and pressed into two 640 pound blocks, then aged for 42 days. In addition, one block each of the fat free cheddar, full fat mild cheddar, and reduced fat two percent mild cheddar was produced for the trial using conventional cheese make procedures, packaged, and cured for 42 days. The blocks were converted into 10 ounce chunks and V-shreds after the initial aging period.

The cheese blend chunks and shreds were evaluated by a team of experts for flavor and texture compared to the fat free cheddar, full fat mild cheddar, and conventional reduced fat two percent mild cheddar. The cheese blend had flavor comparable to full fat mild cheddar. It was less sour than the conventional two percent mild cheddar and had strong buttery, cheesy, and dairy acid flavor notes. In addition, the cheese blend shreds performed comparably to full fat mild cheddar shreds during melt test analysis.

Fat, moisture, salt, and pH were measured analytically for the reduced fat cheese blend. The analytical data for the reduced fat cheese blend is provided in the table below, with analytical data for fat free cheddar, full fat mild cheddar, and two percent cheddar data from Example 5 above. The reduced fat cheese blend was close to a 50 percent fat reduction from full fat cheddar cheese.

| | Fat Free | Full Fat Mild | | Reduced Fat |
|---|---|---|---|---|
| | Cheddar | Cheddar | 2% Cheddar | Cheese Blend |
| Fat | 0.35 | 31.71 | 19.24 | 15.87 |
| Moisture | 56.4 | 39.9 | 48.5 | 46.4 |
| Salt | 1.90 | 2.03 | 1.67 | 2.06 |
| pH | 5.10 | 5.38 | 5.18 | 5.17 |

### Example 7

Various levels of full fat and reduced fat cheese were blended as indicated below. Respondents were asked to rate the six cheeses on an 8.5 inch scale with “taste of reduced-fat cheddar” at one end, and “taste of full-fat cheddar” at the other end. Average scores reported below are the distance in inches from the left end of the scale (“taste of reduced-fat cheddar”).

| | | | | | | |
|---|---|---|---|---|---|---|
| Description | Kraft 2% | 90/10 | 80/20 | 70/30 | Alpine Lace | Cracker |
| | Sharp | | | | 25% Reduced | Barrel |
| | Cheddar | | | | Fat | Sharp |
| | | | | | | Cheddar |
| Details | 100% | 90% Kraft 2% | 80% Kraft 2% | 70% Kraft 2% | Commercially | 100% |
| | Kraft 2% | Sharp | Sharp | Sharp | available | Cracker |
| | Sharp | Cheddar/ | Cheddar/ | Cheddar/ | natural cheese | Barrel full- |
| | Cheddar - | 10% Cracker | 20% Cracker | 30% Cracker | slices | fat sharp |
| | Extruded | Barrel full-fat | Barrel full-fat | Barrel full-fat | | cheddar |
| | | cheddar - | cheddar - | cheddar - | | cheese |
| | | Extruded | Extruded | Extruded | | |
| Fat | 38% | 34% | 31% | 27% | 25% | 0% |
| Reduction | | | | | | |
| Average | 3.28 | 3.38 | 5.33 | 5.31 | 0.48 | 7.97 |
| Score | | | | | | |

All references cited herein are incorporated by reference.

What is claimed is:

1. A method of producing a reduced fat cheese product comprising:
curing fresh, reduced fat curds to produce a reduced fat cheese; and
curing fresh, full fat curds to produce a full fat cheese; and
mixing together the reduced fat cheese and the full fat cheese at a ratio of about 30 to 80 percent reduced fat cheese to about 20 to 70 percent full fat cheese; and
extruding the mixture of reduced fat cheese and full fat cheese;
equilibrating the mixture of reduced fat cheese and full fat cheese, wherein the resulting reduced fat cheese product has enhanced organoleptic properties over conventional reduced fat cheese having the same fat content.

2. The method of claim 1 wherein the reduced fat cheese product is cheddar cheese.

3. The method of claim 1 wherein the enhanced organoleptic properties is any of the group consisting of flavor, texture, mouthfeel, and taste.

4. The method of claim 1 wherein the reduced fat cheese and the full fat cheese are mixed together at a ratio of 40 to 50 percent reduced fat cheese to about 50 to 60 percent full fat cheese.

5. The method of claim 1 wherein the reduced fat cheese is produced from one percent milk.

6. The method of claim 1 wherein the full fat cheese is produced from whole milk.

7. The method of claim 1 wherein the reduced fat cheese product has between 25 and 50 percent less fat than full fat cheese.

8. A method of producing a reduced fat cheese product comprising:
mixing together fresh, reduced fat curds and fresh, full fat curds at a ratio of about 30 to 80 percent fresh, reduced fat curds to about 20 to 70 percent fresh, full fat curds; and
aging the mixture of fresh, reduced fat curds and fresh, full fat curds, wherein the resulting reduced fat cheese product has enhanced organoleptic properties over conventional reduced fat cheese having the same fat content.

9. The method of claim 8 wherein the reduced fat cheese product is cheddar cheese.

10. The method of claim 8 wherein the enhanced organoleptic properties is any of the group consisting of flavor, texture, mouthfeel, and taste.

11. The method of claim 8 wherein the fresh, reduced fat curds and the fresh, full fat curds are mixed together at a ratio of 40 to 50 percent reduced fat curds to about 50 to 60 percent full fat curds.

12. The method of claim 8 wherein the fresh, reduced fat curds are produced from any of the group consisting of one percent milk and fat free milk.

13. The method of claim 8 wherein the fresh, full fat curds are produced from whole milk.

14. The method of claim 8 wherein the reduced fat cheese product has between 25 and 50 percent less fat than full fat cheese.

15. The method of claim 8 wherein mixing together fresh, reduced fat curds and fresh, full fat curds is accomplished by stirring.

16. A reduced fat cheese product comprising:
a mixture of reduced fat cheese and full fat cheese comprising:
about 30 to 80 percent reduced fat cheese; and
about 20 to 70 percent full fat cheese; and
fat in the range of about 15 and 26 percent; and
enhanced organoleptic properties over conventional reduced fat cheese.

17. The reduced fat cheese product of claim 16 having between 25 and 50 percent less fat than that of full fat cheese.

18. The reduced fat cheese product of claim 16 wherein the reduced fat cheese product is cheddar cheese.

19. The reduced fat cheese product of claim 16 wherein the enhanced organoleptic properties is any of flavor, texture, mouthfeel, and taste.

20. The reduced fat cheese product of claim 16 wherein the reduced fat cheese and the full fat cheese are mixed together at a ratio of 40 to 50 percent reduced fat cheese to about 50 to 60 percent full fat cheese.

21. The reduced fat cheese product of claim 16 wherein the reduced fat cheese is produced from one percent milk.

22. The reduced fat cheese product of claim 16 wherein the full fat cheese is produced from whole milk.

23. The reduced fat cheese product of claim 16 wherein the mixture of reduced fat cheese and full fat cheese is extruded.

24. A reduced fat cheese product comprising:
a mixture of fresh, reduced fat cheese curds and fresh, full fat cheese curds comprising:
about 30 to 80 percent fresh, reduced fat cheese curds; and
about 20 to 70 percent fresh, full fat cheese curds; and
fat in the range of about 15 and 26 percent; and
enhanced organoleptic properties over conventional reduced fat cheese.

25. The reduced fat cheese product of claim 24 having between 25 and 50 percent less fat than that of full fat cheese.

26. The reduced fat cheese product of claim 24 wherein the reduced fat cheese product is cheddar cheese.

27. The reduced fat cheese product of claim 24 wherein the enhanced organoleptic properties is any of flavor, texture, mouthfeel, and taste.

28. The reduced fat cheese product of claim 24 wherein the reduced fat cheese and the full fat cheese are mixed together at a ratio of 40 to 50 percent reduced fat cheese to about 50 to 60 percent full fat cheese.

29. The reduced fat cheese product of claim 24 wherein the fresh, reduced fat curds are produced from any of the group consisting of one percent milk and fat free milk.

30. The reduced fat cheese product of claim 24 wherein the fresh, full fat cheese curds are produced from whole milk.

31. The reduced fat cheese product of claim 24 wherein the mixture of fresh, reduced fat cheese curds and fresh, full fat cheese curds is accomplished by stirring.
